(19) United States
(12) Patent Application Publication
(10) Pub. No.: US 2012/0159387 A1
(43) Pub. Date: Jun. 21, 2012

(54) ICON DISPLAY METHOD AND APPARATUS IN PORTABLE TERMINAL

(75) Inventors: Hyun-Chul OH, Seoul (KR); Jun-Chul KANG, Daegu (KR)

(73) Assignee: SAMSUNG ELECTRONICS CO., LTD., Gyeonggi-Do (KR)

(21) Appl. No.: 13/326,771

(22) Filed: Dec. 15, 2011

(30) Foreign Application Priority Data
Dec. 20, 2010 (KR) 10-2010-0131062

(51) Int. Cl. G06F 3/048

(52) U.S. Cl. 715/808; 715/835

(57) ABSTRACT

An icon display method in a portable terminal includes: displaying icons corresponding to predetermined menu functions on a standby screen; recognizing a user's gesture for at least two icons among the displayed icons; and executing a pre-set menu corresponding to the recognized icons.

### CLAIM OF PRIORITY

This application claims priority under 35 U.S.C. §119 to an application entitled “Icon Display Method and Apparatus in Portable Terminal” filed in the Korean Intellectual Property Office on Dec. 20, 2010 and assigned Serial No. 10-2010-0131062, the contents of which are incorporated herein by reference.

### BACKGROUND OF THE INVENTION

1. Field of the Invention

The present invention relates generally to an icon display method and apparatus for synthesizing at least two icons through a touch and drag operation displayed on a standby screen of the portable terminal through a touch and drag operation.

2. Description of the Related Art

Due to the technology development of mobile devices, a mobile communication terminal today provides various multimedia functions in addition to the traditional telephone call function and accesses Internet. Various applications are executed in a device, such as a smart phone, having a Personal Digital Assistant (PDA) function and various application services, such as MP3, camera, wireless Internet, email, and messaging services are available.

According to a growing demand number of application services, various menus for executing a corresponding application have been introduced. As various applications are equipped in a single terminal, an icon for directly executing a specific menu with a single selection must be individually selected to use a particular service function provided by each of the applications.

As such, although the number of icons increases according to an increase of various service functions, all the icons cannot be displayed on a single screen of a portable terminal having a limited display area. Thus, since a frequent screen change is necessary and each of the displayed icons corresponds to a single service function to execute only one single service function via a single selection, a plurality of icons must be individually selected to use a multi-tasking function.

### SUMMARY OF THE INVENTION

An object of the present invention is to substantially solve at least the above problems and/or disadvantages and to provide at least the advantages below. Accordingly, an object of the present invention is to generate and display a user adaptive superior icon in which various functions are combined by selectively synthesizing specific icons related to a service function to be executed from among a plurality of icons displayed on a standby screen of a portable terminal.

According to one aspect of the present invention, an icon display method in a portable terminal includes: displaying icons corresponding to predetermined menu functions on a standby screen; recognizing a user's gesture for at least two icons among the displayed icons; and executing a pre-set menu corresponding to the recognized icons.

According to another aspect of the present invention, an icon display apparatus in a portable terminal includes: a display unit for displaying icons corresponding to predetermined menu functions; and a controller for controlling to display icons on the display unit, recognize a user's gesture for at least two icons among the displayed icons, and execute a pre-set menu corresponding to the recognized icons, wherein when the user's gesture for the icons is recognized, a first menu on whether a first service related to the at least two icons is set is displayed, and if the first service is set according to the first menu, a second service different from the first service corresponding to the at least two icons is executed.

### BRIEF DESCRIPTION OF THE DRAWINGS

The above features and advantages of the present invention will become more apparent from the following detailed description when taken in conjunction with the accompanying drawing in which:

FIG. 1 is a flowchart of an icon display method in a portable terminal according to a preferred embodiment of the present invention;

FIG. 2 is a block diagram of an icon display apparatus in a portable terminal according to a preferred embodiment of the present invention; and

FIG. 3 illustrates screens displayed while the icon display method in a portable terminal is performed according to a preferred embodiment of the present invention.

### DETAILED DESCRIPTION OF THE INVENTION

Preferred embodiments of the present invention will be described herein below with reference to the accompanying drawings. In the following description, although many specific items are shown, they are only provided to help general understanding of the present invention, and it will be understood by those of ordinary skill in the art that these specific items can be modified or changed within the scope of the present invention.

The present invention relates to an icon display of a portable terminal, and in more detail, is to selectively synthesize specific icons among a plurality of icons corresponding to predetermined menus displayed on a standby screen of the portable terminal and display the synthesized icon. To do this, the present invention provides technology of generating a superior icon in which unit menu functions performed by respective icons are combined by recognizing a touch & drag of a user, which has occurred for at least two icons, and setting a pre-set service corresponding to the recognized icons and executing the unit menu functions of the respective icons by a single selection of the generated superior icon without individually selecting icons related to a menu function for displaying and executing the respective icons.

In addition, a portable terminal according to a preferred embodiment of the present invention may include all information communication devices, such as a digital broadcast terminal, a Personal Digital Assistant (PDA), a smart phone, a third generation (3G) terminal, e.g., an International Mobile Telecommunication 2000 (IMT-2000) terminal, a Wideband Code Division Multiple Access (WCDMA) terminal, a Global System for Mobile Communication Packet Radio Service (GSM/GPRS) terminal, and a Universal Mobile Telecommunication Service (UTMS) terminal, and multimedia devices. However, it will be easily understood by those of ordinary skill in the art that the configuration according to a preferred embodiment of the present invention, which is disclosed in the specification, may be also applied to fixed terminals, such as a digital TV and a desktop computer, except for a case capable of being applied to only the portable terminal.

The portable terminal according to a preferred embodiment of the present invention is implemented in a touch screen method, and in particular, the present invention provides technology of combining icons related to a specific service function by sensing a user's gesture occurring in a display area of the portable terminal and generating and displaying a new icon associated with the combined icons.

In addition, in prior to a detailed description of the present invention, the terminology, a user's gesture, described below, indicates “intention” of a user to input something through an input unit, e.g., a touch screen, of the portable terminal and points a specific icon displayed on the touch screen by a contact, i.e., a touch. For example, the user's gesture on the portable terminal includes a single tap for selecting or activating an icon, a drag and drop, which is an operation of pressing and dragging a first icon displayed on the touch screen to a point at which a second icon is located, and a long touch press, which is an operation of pressing an icon for a long while. Although the touch, the drag and drop, and the long touch press are described as examples for the user's gesture in embodiments of the present invention, the present invention is not limited thereto.

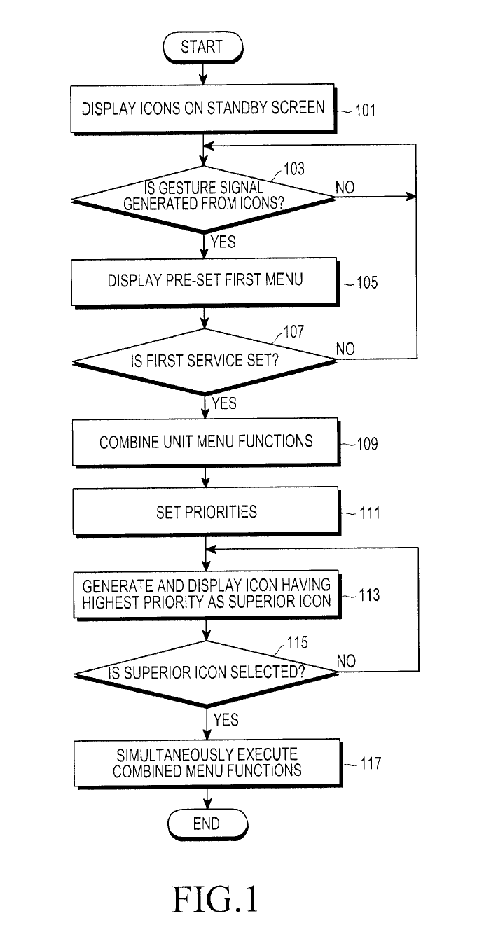

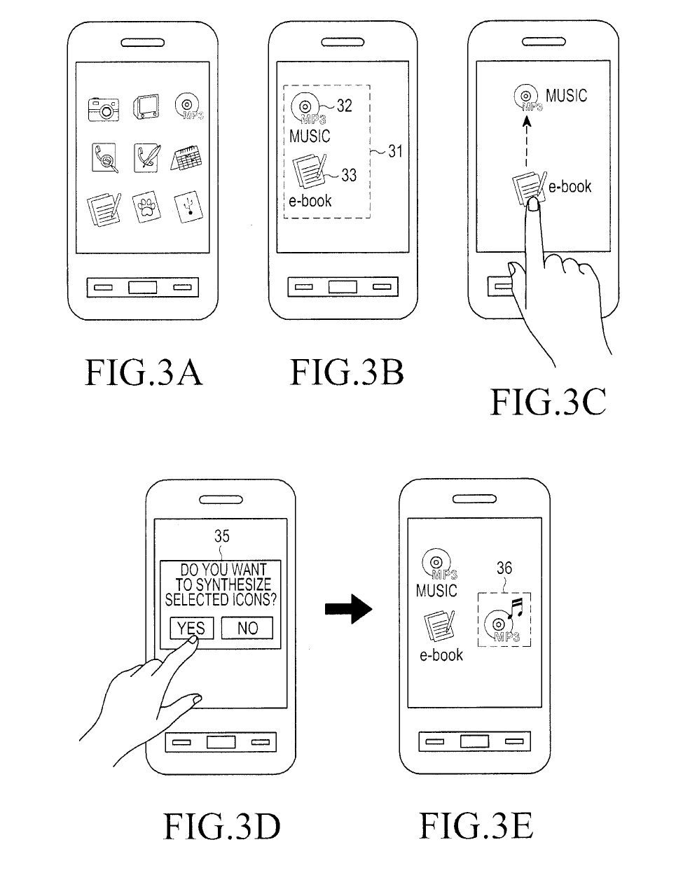

Hereinafter, an icon display method in a portable terminal according to a preferred embodiment of the present invention is described in detail with reference to FIGS. 1 and 3.

FIG. 1 is a flowchart of an icon display method in a portable terminal according to a preferred embodiment of the present invention.

Referring to FIG. 1, in step 101, icons corresponding to a service menu function supported by the portable terminal are displayed.

A screen to which step 101 is applied is shown in FIG. 3A, and icons for directly executing service menu functions, such as phone book, message, e-mail, netbook, media player service menu functions, of various applications supported by the portable terminal may be displayed in a display unit area.

Thereafter, as shown in FIG. 3B, a user selects at least two icons 32 and 33 to be combined from among a plurality of icons displayed on a standby screen of the display unit area, and the terminal recognizes whether a signal associated with a user's gesture is input from the at least two icons, i.e., the selected icons 32 and 33, among the plurality of icons displayed in the display unit area in step 103. That is, when two icons are selected from FIG. 3a by contacting icon 32 and icon 33, then FIG. 3b is displayed. Thereafter, as explained in the next paragraph, the user points icon 33 and drags and drop onto icon 32.

Here, the user's gesture is a gesture for initiating and executing an action related to a plurality of icons through an interaction with a user interrupt in the display unit area, indicates any one pointing operation of a touch, a drag and drop, and a long press touch occurring in the display unit area due to a user's contact onto a displayed icon. Such contact is input by a user input means, such as, a finger tip or a stylus pen.

A screen to which step 103 is applied is shown in FIG. 3C showing that a user's drag and drop gesture is performed for the icon 33 related to the e-book service menu function to the icon 32 related to a music service menu function.

As a result of the operation in step 103, if the user's gesture is recognized for at least two icons 32 and 33, a pre-set first menu is displayed in response to the recognized icons 32 and 33 in step 105.

In step 105, in detail, when the user's gesture is recognized for the at least two icons 32 and 33, the first menu related to whether a first service associated with the icons 32 and 33 is set is displayed, wherein the displayed first menu indicates that a window 35 for asking whether a superior icon corresponding to a menu function capable of executing the icons 32 and 33 at the same time by combining unit menu functions of the icons 32 and 33 is generated is displayed in a pop-up form. On a screen to which this operation is applied, the window 35 associated with whether the superior icon is generated is displayed in the display unit area in a pop-up window form, such as “do you want to synthesize selected icons?” as shown in FIG. 3D.

As a result of step 105, whether the first service according to the first menu is set is asked to the user in step 107, and if the first service is set in step 107, the unit menu functions of the icons 32 and 33 are combined in step 109.

At the same time, priorities of the unit menu functions of the combined icons 32 and 33 are set in step 111, and a corresponding icon having the highest priority among the set priorities is generated and displayed in step 113 as the superior icon in which the unit menu functions of the icons 32 and 33 are combined.

The operation of step 111 relates to a second service different from the first service associated with the first menu displayed in step 105 and indicates that an icon associated with a menu function corresponding to the highest priority by setting priorities of unit menu functions of corresponding icons when the first service is provided is generated and displayed as a superior icon. Likely the display of the first menu in step 105, a display of a second menu related to the second service, i.e., a window for setting priority, is displayed in a pop-up form.

In step 115, the generated superior icon is displayed in an adjacent area of the individual icons 32 and 33 included in the superior icon, and if a user's gesture is recognized for the superior icon, that is, if the superior icon is selected by the user, the unit menu functions of the individual icons 32 and 33, i.e., a service function corresponding to the superior icon, are simultaneously executed in step 117.

The superior icon displayed in an adjacent area of the individual icons 32 and 33 is shown in FIG. 3E with reference numeral 36.

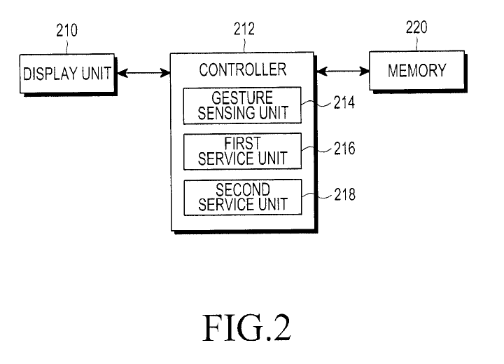

Hereinafter, an icon display apparatus in a portable terminal according to a preferred embodiment of the present invention will now be described in detail with reference to FIG. 2.

FIG. 2 is a block diagram of an icon display apparatus in a portable terminal, according to a preferred embodiment of the present invention.

Referring to FIG. 2, although the icon display apparatus in the portable terminal includes only a display unit 210, a controller 212, and a memory 220, the portable terminal may further include a camera, a speaker, a microphone, and a wireless communication unit.

The display unit 210, which displays icons corresponding to predetermined menu functions, displays procedures and results (e.g., a plurality of service functions and icons of the service functions) executed according to input signals of all service functions supported by the portable terminal under a control of the controller 212 on a screen so as for a user to perceive the procedures and results and outputs a user gesture signal to the controller 212 by generating a contact interrupt when the user contacts a user input means.

The memory 220 may store programs for processing and controlling in the controller 212 and perform a function for temporarily storing input/output data.

The controller 212 includes a gesture sensing unit 214, a first service unit 216, and a second service unit 218 and controls to display icons on the display unit 210, recognize a user's gesture for at least two icons among the displayed icons, and execute a pre-set menu corresponding to the recognized icons.

When the user's gesture for the at least two icons is recognized, the controller 212 controls to display a first menu associated with whether a first service associated with the at least two icons is set, and if the first service is set according to the first menu, the controller 212 controls to execute a second service different from the first service corresponding to the at least two icons.

Here, the pre-set menu is one of a plurality of execution commands included in a menu list applicable to the icons, and the user's gesture indicates a pointing operation for piling other at least one icon on a predetermined icon selected from among the icons displayed on the display unit 210.

In addition, the user's gesture indicates a pointing operation corresponding to one of a long press touch, a tap, a flick, or a drag and drop occurring in an area of the display unit 210 due to a user's contact.

When the user's gesture is recognized for the at least two icons, the controller 212 controls to display a window in a pop-up form by combining unit menu functions of the at least two icons, the window for asking whether a superior icon corresponding to a simultaneously executable menu function is generated.

In addition, if the superior icon is generated, the controller 212 controls to display a window for setting priorities of the unit menu functions of the at least two icons in a pop-up form.

At this time, the controller 212 includes the gesture sensing unit 214 for recognizing and determining the user's gesture for the at least two icons from among the icons displayed on the display unit 210, the first service unit 216 for providing the first service for generating the superior icon associated with the simultaneously executable menu function by combining the unit menu functions of the at least two icons, and the second service unit 218 for setting the priorities of the unit menu functions of the at least two icons when the first service is provided and displaying an icon associated with a menu function corresponding to the highest priority as the superior icon.

According to the present invention, unit menu functions of specific icons may be simultaneously performed with a single selection of a superior icon without individually selecting a plurality of icons by selectively synthesizing the specific icons from among the plurality of icons corresponding to predetermined menu functions displayed in a standby screen of a portable terminal, combining the unit menu functions of the specific icons, and generating the superior icon associated with a simultaneously executable menu function.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

As described above, an operation related to an icon display apparatus and method in a portable terminal in a portable terminal according to the present invention may be achieved. While preferred embodiment of the invention has been described, various changes or modifications in form and details may be made therein without departing from the scope of the invention as defined by the appended claims and equivalents.

What is claimed is:

1. An icon display method in a portable terminal, the icon display method comprising:
displaying a plurality of icons corresponding to predetermined menu functions on a standby screen;
recognizing a contact of at least two icons among the displayed icons; and
executing a pre-set menu corresponding to the recognized icons.

2. The icon display method of claim 1, wherein, when the contact for the at least two icons is recognized, a first menu on whether a first service related to the at least two icons is set is displayed, and if the first service is set according to the first menu, a second service different from the first service corresponding to the at least two icons is executed.

3. The icon display method of claim 1, wherein the pre-set menu is one of a plurality of execution commands included in a menu list applicable to the icons.

4. The icon display method of claim 1, wherein the contact is a pointing operation for piling other at least one icon onto a predetermined icon selected from among the displayed icons.

5. The icon display method of claim 1, wherein the contact is a pointing operation corresponding to one of a long press touch, a tap, a flick, or a drag and drop occurring in a display unit area due to a user's contact.

6. The icon display method of claim 1, wherein, if the contact is recognized for the at least two icons, a window for asking whether a superior icon corresponding to simultaneously executable menu functions is displayed in a pop-up form by combining unit menu functions of the at least two icons.

7. The icon display method of claim 2, wherein the first service generates a superior icon associated with a simultaneously executable menu function by combining unit menu functions of the at least two icons, and
the second service displays an icon associated with a menu function corresponding to the highest priority as the superior icon by setting priorities of unit menu functions of the at least two icons when the first service is provided.

8. The icon display method of claim 1, wherein the contact is a gesture for calling and executing an action related to a plurality of icons through an interaction with a user interrupt in a display unit area of the portable terminal.

9. An icon display apparatus in a portable terminal, comprising:
a display unit for displaying a plurality of icons corresponding to predetermined menu functions; and
a controller for controlling to display icons on the display unit, recognize a contact of at least two icons among the displayed icons, and execute a pre-set menu corresponding to the recognized icons,
wherein when the contact for the icons is recognized, a first menu on whether a first service related to the at least two icons is set is displayed, and if the first service is set according to the first menu, a second service different from the first service corresponding to the at least two icons is executed.

10. The icon display apparatus of claim 9, wherein the pre-set menu is one of a plurality of execution commands included in a menu list applicable to the icons.

11. The icon display apparatus of claim 9, wherein the contact is a pointing operation for piling other at least one icon onto a predetermined icon selected from among the displayed icons.

12. The icon display apparatus of claim 9, wherein the contact is a pointing operation corresponding to one of a long press touch, a tap, a flick, or a drag and drop occurring in a display unit area due to a user's contact.

13. The icon display apparatus of claim 9, wherein, if the contact is recognized for the at least two icons, the controller controls so that a window for asking whether a superior icon corresponding to simultaneously executable menu functions is displayed in a pop-up form by combining unit menu functions of the at least two icons.

14. The icon display apparatus of claim 9, wherein the controller comprises:
a gesture sensing unit for recognizing and determining the contact for the at least two icons from among the icons displayed on the display unit;
a first service unit for providing the first service for generating a superior icon associated with a simultaneously executable menu function by combining unit menu functions of the at least two icons; and
a second service unit for setting priorities of the unit menu functions of the at least two icons when the first service is provided and displaying an icon associated with a menu function corresponding to the highest priority as the superior icon.

15. The icon display apparatus of claim 9, wherein the contact is a gesture for calling and executing an action related to a plurality of icons through an interaction with a user interrupt in a display unit area of the portable terminal.

16. A computer-readable recording medium storing a computer-readable program for executing the icon display method of claim 1.
